(19) United States
(12) Patent Application Publication
(10) Pub. No.: US 2013/0022297 A1
(43) Pub. Date: Jan. 24, 2013

(54) ANTI-LOOSE MECHANISM OF RELATIVE SLIDING DEVICE

(71) Applicants: CHIEN CHENG MAI, NEW TAIPEI CITY (TW); WAY HAN DAI, NEW TAIPEI CITY (TW)

(72) Inventors: CHIEN CHENG MAI, NEW TAIPEI CITY (TW); WAY HAN DAI, NEW TAIPEI CITY (TW)

(73) Assignee: FIRST DOME CORPORATION, NEW TAIPEI CITY (TW)

(21) Appl. No.: 13/188,573

(22) Filed: Jul. 22, 2011

(51) Int. Cl. F16C 29/02

(52) U.S. Cl. 384/26

(57) ABSTRACT

An anti-loose mechanism of a relative sliding rail includes a sliding-guided member connected to a sliding member and a main frame capable of being combined to a pivotal seat. The sliding-guided member includes a sliding-guided portion and at least one sliding protrusion disposed next to the sliding-guided portion. The main frame pivoted to a relative sliding member includes an accommodation portion slidably jacketed to the sliding-guided portion of the sliding-guided member. A protruded abutment disposed outside next to the accommodation portion is placed on a relative sliding path (end) of the sliding protrusion of the sliding-guided member. When the main frame and the sliding-guided member are relatively slid to an end for opening, the protruded abutment and the sliding protrusion of the sliding-guided member are appropriately packed and abutted to each other, to stably position the sliding member and the relative sliding member therebetween for the next operations.

### BACKGROUND OF THE INVENTION

1. Field of the Invention

The present invention relates to an anti-loose mechanism of a relative sliding device, and in particular relates to a mechanism capable of assuring a smooth sliding process and retaining a stable positioning effect when sliding members are fully opened or lifted.

2. Description of the Related Art

Various sliding-cover structures are commonly applied in different electronic devices. For example, “SLIDING MODULE AND PROTABLE ELECTRONIC DEVICE USING THE SAME” of Taiwan Patent Publication No. I328088 is an invention patent case, providing a fixed mechanism fixedly connected with a fixed frame and a moving mechanism fixedly connected with a movable frame. Inversely-bent hook portions disposed at both sides of the fixed frame are utilized to jacket and accommodate the edge of the two sides of the movable frame, so that the moving mechanism can be moved between a first position and a second position on the fixed frame via the movable frame relative to the fixed mechanism, and a driving force required by the moving mechanism can be provided by a wire torsion elastic member.

Further, “SLIDING-COVER DEVICE” of Taiwan Patent Publication No. I280031 is an invention patent case, including a base plate provided with guiding slot and sliding rail, an upper cover provided with a long slotted hole, and an elastic member disposed on the long slotted hole of the upper cover. The upper cover can be embedded in the sliding rail of the base plate. The guiding slot of the base plate is formed with a curve path having a surpass point. The elastic member includes two springs having fixed ends to be fixedly disposed on the outside end of the long slotted hole of the upper cover, respectively. Slide-roll members, which are respectively disposed on the free ends of the two springs and extended along in the long slotted hole of the upper cover, are displaced along the guiding slot of the base plate and pulls the springs to expand or contract when the upper cover is moved. In any case, when the slide-roll members crosses over the surpass point of the guiding slot of the base plate, the upper cover and the base plate can be automatically extended or contracted by the pulling of the elastic members.

In the structures above, because the movable frame (the upper cover) and the fixed frame (the base plate) can be relatively slid to each other, an adequate clearance shall be preserved at a connection portion therebetween to prevent a large frictional force caused by an extreme packing, and thus a smooth relative sliding of the movable frame (the upper cover) and the fixed frame (the base plate) in the opening or closing process can be achieved. Further, when the opening or closing process of the movable frame (the upper cover) and the fixed frame (the base plate) is completed, or when the movable frame (the upper cover) and the fixed frame (the base plate) are performed by other processes (e.g., the lifting of the sliding cover or monitor), the movable frame (the upper cover) and the fixed frame (the base plate) are intended to have a stable positioning effect and a normal operation without shaking or loosening therebetween. Accordingly, for these related arts, it is essential to provide a smooth sliding effect for an assembly of a sliding member and a relative sliding member, and a stable positioning effect is also required when their opening, closing or other process is performed.

### BRIEF SUMMARY OF THE INVENTION

In view of this, the invention provides an anti-loose mechanism for overcoming the disadvantages of the conventional sliding-cover structures.

The main purpose of the present invention is to provide an anti-loose mechanism of a relative sliding rail with a sliding smoothness of between a sliding member and a relative sliding member and a stable positioning effect when the opening, closing or other process is performed.

To attain the purposes and effects above, the technical way adopted by the present invention comprises a sliding-guided member connected to a sliding member and a main frame capable of linking to a relative sliding member. The sliding-guided member includes a sliding-guided portion and at least one sliding protrusion disposed next to the sliding-guided portion. The main frame includes an accommodation portion slidably jacketed to the sliding-guided portion of the sliding-guided member, and a protruded abutment disposed outside next to the accommodation portion is placed on an end of a relative sliding path of the sliding protrusion of the sliding-guided member. When the main frame and the sliding-guided member are relatively slid to an end for opening, the protruded abutment and the sliding protrusion of the sliding-guided member are appropriately packed and abutted to each other, to form an open positioning between the sliding member and the relative sliding member.

According to the above structure, the sliding-guided portion of the sliding-guided member comprises at least one end including a bent blocking portion utilized to abut against an interior of the accommodation portion of the main frame for positioning when the main frame is relatively slid to the end of the sliding-guided portion of the sliding-guided member.

According to the above structure, the sliding-guided portion of the sliding-guided member comprises two ends respectively including the bent blocking portion.

According to the above structure, the sliding protrusion is disposed on the sliding-guided portion, and the protruded abutment is disposed in the accommodation portion.

According to the above structure, the anti-loose mechanism of the relative sliding rail further comprises a pivotal seat pivotally disposed on the relative sliding member.

According to the above structure, the protruded abutment is disposed on the pivotal seat.

According to the above structure, the pivotal seat is connected to a pivotal frame via a pivot shaft, and the pivotal frame is connected to the relative sliding member.

According to the above structure, the main frame further comprises at least one hollow portion communicated to the accommodation portion, the pivotal seat comprises a rolling member corresponding to the hollow portion, and the rolling member of the pivotal seat is abutted against the sliding-guided portion of the sliding-guided member by passing through the hollow portion of the main frame.

According to the above structure, the rolling member of the pivotal seat is pivotally disposed on an adjusting seat abutted against the pivotal seat via at least one elastic member.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a structural exploded view of the invention;

FIG. 2 is a schematic view showing an integral assembly of the invention;

FIG. 3 is a sectional view showing an integral assembly of the invention;

FIG. 3A is an enlarged sectional view of a portion ‘A’ of FIG. 3;

FIG. 3B is an enlarged sectional view of a portion ‘B’ of FIG. 3;

FIG. 3C is an enlarged sectional view of a portion ‘C’ of FIG. 3;

FIG. 4 is a schematic sectional view showing an opened sliding member of the invention;

FIG. 4A is an enlarged sectional view of a portion ‘D’ of FIG. 4;

FIG. 4B is an enlarged sectional view of a portion ‘E’ of FIG. 4; and

FIG. 5 is a schematic sectional view showing a lifted sliding member of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

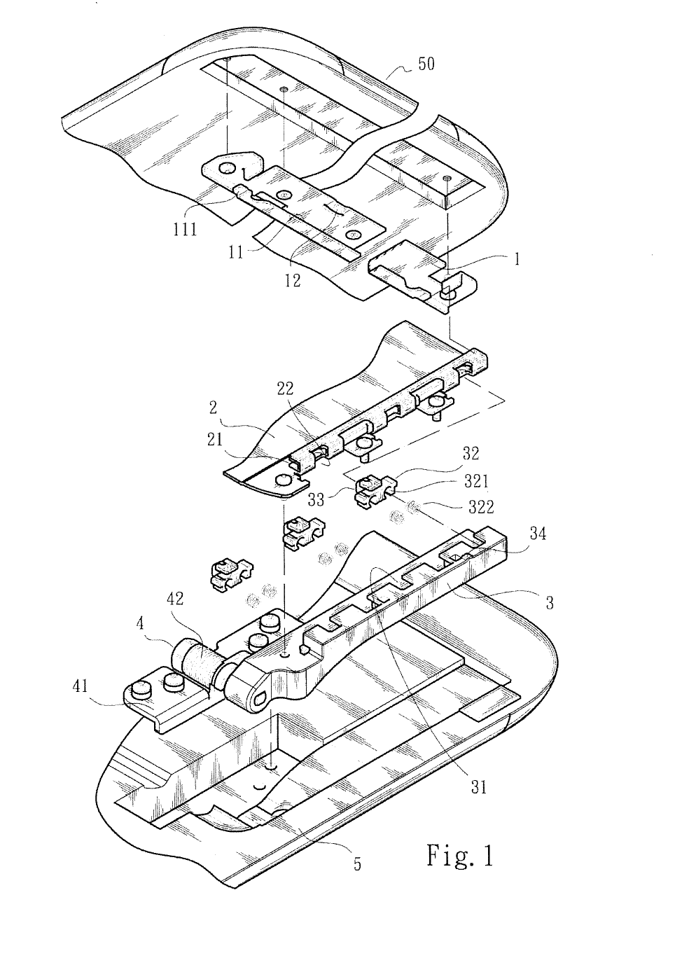

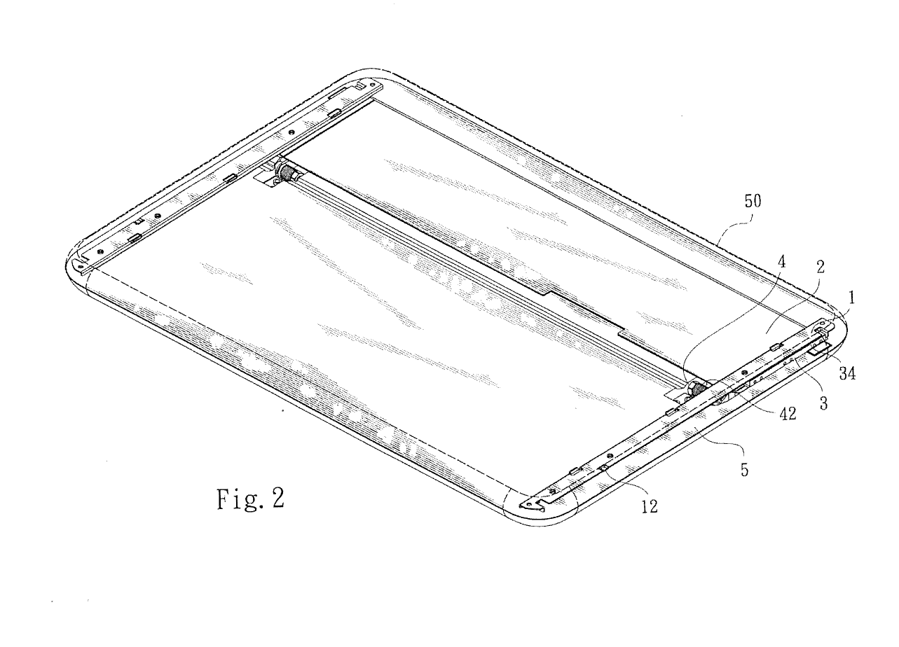

Referring to FIGS. 1 and 2, an anti-loose mechanism of a relative sliding rail mainly comprises a sliding-guided member 1 and a main frame 2. The sliding-guided member 1, capable of being connected to at least one side of a sliding member 50, comprises a sliding-guided portion 11 and at least one sliding protrusion 12 protectively disposed next to the sliding-guided portion 11, wherein two ends of the sliding-guided portion 11 are respectively provided with a bent blocking portion 111. In this embodiment, the sliding member 50 can be a sliding cover of an electronic device, and the sliding-guided portion 11 can be a guiding rail. In the application, the sliding-guided members 1 extended in parallel are respectively disposed at two sides of the sliding member 50, allowing the sliding-guided portion 11 of the sliding-guided members 1 to outwardly extend toward the two sides of the sliding member 50. The main frame 2 can be combined to a pivotal seat 3, and the main frame 2 can be linked to a relative sliding member 5 via the pivotal seat 3. In this embodiment, the relative sliding member 5 can be a seat of an electronic device. The main frame 2 comprises an accommodation portion 21 slidably jacketed to the sliding-guided portion 11 of the sliding-guided member 1, and a protruded abutment 34 disposed outside next to the accommodation portion 21 is appropriately disposed on one end of a relative sliding path of the sliding protrusion 12 of the sliding-guided member 1. The main frame 2 further comprises a plurality of hollow portions 22 respectively communicated to the accommodation portion 21, the pivotal seat 3 comprises a plurality of accommodation spaces 31 respectively corresponding to the hollow portions 22 of the main frame 2, and a plurality of adjusting seats 32 are respectively received in the accommodation spaces 31 of the pivotal seat 3. Each of the adjusting seats 32 is pivoted with a rolling member 33 e.g., a roller, one side of the adjusting seat 32 apart from the rolling member 33 is provided with a recess 321, and a plurality of elastic members 322 respectively received in the recesses 321 of the adjusting seat 32 are abutted against an interior of the accommodation spaces 31 of the pivotal seat 3, so that the adjusting seats 32 can drive the rolling members 33 passing through the hollow portions 22 of the main frame 2 to elastically abut against the sliding-guided portion 11 of the sliding-guided member 1, and therefore the main frame 2 can stably and smoothly slide on the sliding-guided portion 11 of the sliding-guided member 1. One end of the pivotal seat 3 is pivoted to a pivotal frame 41 disposed on the relative sliding member 5 via a pivot shaft 4, and the pivot shaft 4 is further packed on the pivotal frame 41 via a pivotal elastic member 42, so that the pivotal seat 3 can be centrally pivoted about the pivot shaft 4 and packed to position thereof at any lifting angle.

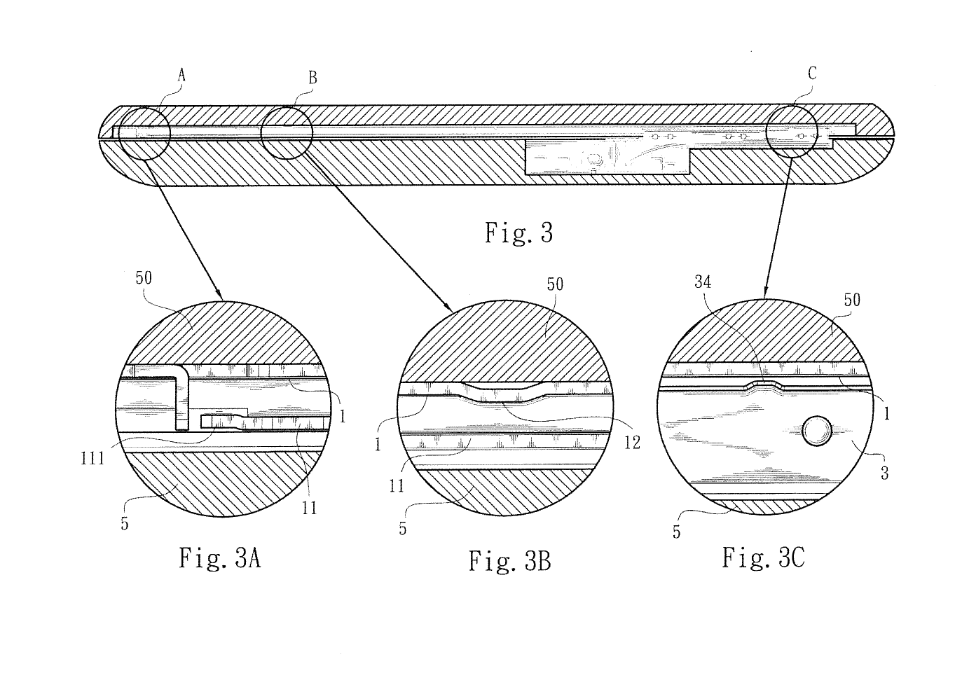

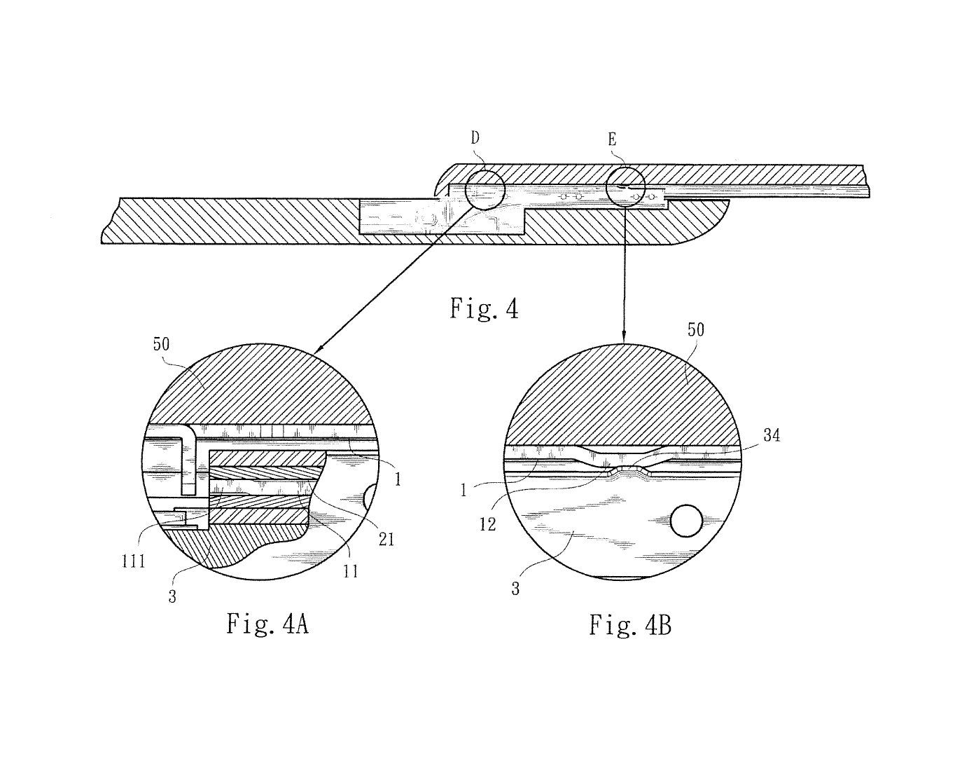

Referring to FIGS. 3 to 5, in the application of the structure of the invention, when the sliding member 50 is closed or received on the relative sliding member 5, the blocking portion 111 of the sliding-guided member 1 (shown in FIG. 3A), the sliding protrusion 12 of the sliding-guided member 1 (shown in FIG. 3B) and the protruded abutment 34 (shown in FIG. 3C) do not cause any interferes and block movement to other components; meanwhile the sliding member 50 and the relative sliding member 5 form an assembly being suitable for push sliding. When the forced sliding member 50 drives the sliding-guided member 1 to relatively slide to a status of full-open positioning with respect to the accommodation portion 21 of the main frame 2 disposed on the relative sliding member 5 (as shown in FIG. 4), the sliding protrusion 12 of the sliding-guided member 1 is appropriately abutted against the protruded abutment 34 (shown in FIG. 4B), and the blocking portion 111 of the sliding-guided portion 11 is also packed and contacted by an inner wall of the accommodation portion 21 of the main frame 2 (shown in FIG. 4A). Accordingly, that the sliding-guided member 1 and the main frame 2 is stably and fixedly positioned therebetween, and the sliding member 50 and the relative sliding member 5 are stably positioned therebetween to be suitable for other processes (e.g., the operation of a keyboard disposed on the relative sliding member 5).

In the structure above, except of the protruded abutment 34 being directly formed next to the accommodation portion 21 of the main frame 2 or formed on the pivotal seat 3, it is possible to attain the same positioning effect by locating the protruded abutment 34 at the relative sliding path of the sliding protrusion 12 of the sliding-guided member 1.

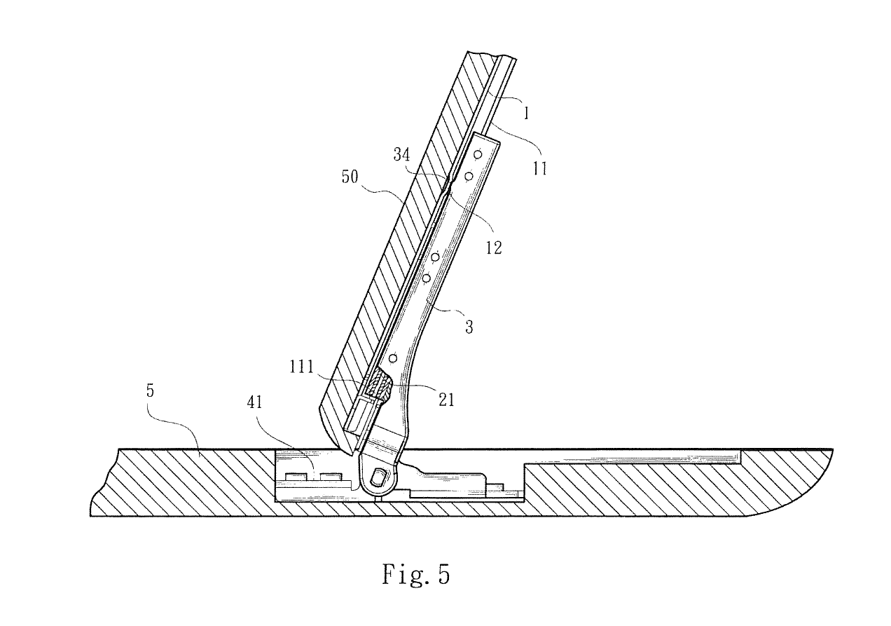

When the sliding member 50 (the sliding-guided member 1) and the relative sliding member 5 (the main frame 2) are stably and fixedly positioned to be located at a full-open position, the sliding member 50 can be lifted to link the pivotal seat 3 to centrally pivot about the pivot shaft 4, and the pivotal elastic member 42 packed between the pivot shaft 4 and the pivotal frame 41 is utilized to position the pivotal seat 3 (the sliding member 50) at any lifting angle (as shown in FIG. 5), thereby increasing the operating convenience.

Except of the sliding protrusion 12 to be disposed next to the sliding-guided portion 11 of the sliding-guided members 1 in the structure of the invention, the sliding protrusion 12 can be disposed on other portions (e.g., the sliding-guided portion 11) according to the requirement, and the protruded abutment 34 can be relatively disposed in the accommodation portion 21 of the main frame 2 for abutting to each other to form a positioning and anti-loose function.

In summary, the anti-loose mechanism of the relative sliding rail of the invention provides with an effective inner space allocation and great versatility. While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An anti-loose mechanism of a relative sliding rail, at least comprising:
at least one sliding-guided member connected to a sliding member, comprising a sliding-guided portion and a sliding protrusion; and
at least one main frame being linkable to a relative sliding member, comprising an accommodation portion slidably jacketed to the sliding-guided portion of the sliding-guided member, and a protruded abutment placed on a relative sliding path of the sliding protrusion of the sliding-guided member, so that the protruded abutment and the sliding protrusion of the sliding-guided member are abutted to each other to form a positioning and anti-loose function when the protruded abutment and the sliding protrusion of the sliding-guided member are relatively slid to correspond to each other.

2. The anti-loose mechanism of the relative sliding rail as claimed in claim 1, wherein the sliding-guided portion of the sliding-guided member comprises at least one end including a bent blocking portion utilized to abut against an interior of the accommodation portion of the main frame to form the positioning and anti-loose function when the main frame is relatively slid to the end of the sliding-guided portion of the sliding-guided member.

3. The anti-loose mechanism of the relative sliding rail as claimed in claim 2, wherein the sliding-guided portion of the sliding-guided member comprises two ends respectively including the bent blocking portion.

4. The anti-loose mechanism of the relative sliding rail as claimed in claim 1, wherein the sliding protrusion is disposed on the sliding-guided portion, and the protruded abutment is disposed in the accommodation portion.

5. The anti-loose mechanism of the relative sliding rail as claimed in claim 2, wherein the sliding protrusion is disposed on the sliding-guided portion, and the protruded abutment is disposed in the accommodation portion.

6. The anti-loose mechanism of the relative sliding rail as claimed in claim 3, wherein the sliding protrusion is disposed on the sliding-guided portion, and the protruded abutment is disposed in the accommodation portion.

7. The anti-loose mechanism of the relative sliding rail as claimed in claim 4 further comprising a pivotal seat pivotally disposed on the relative sliding member.

8. The anti-loose mechanism of the relative sliding rail as claimed in claim 5 further comprising a pivotal seat pivotally disposed on the relative sliding member.

9. The anti-loose mechanism of the relative sliding rail as claimed in claim 6 further comprising a pivotal seat pivotally disposed on the relative sliding member.

10. The anti-loose mechanism of the relative sliding rail as claimed in claim 7, wherein the pivotal seat is connected to a pivotal frame via a pivot shaft, and the pivotal frame is connected to the relative sliding member.

11. The anti-loose mechanism of the relative sliding rail as claimed in claim 8, wherein the pivotal seat is connected to a pivotal frame via a pivot shaft, and the pivotal frame is connected to the relative sliding member.

12. The anti-loose mechanism of the relative sliding rail as claimed in claim 9, wherein the pivotal seat is connected to a pivotal frame via a pivot shaft, and the pivotal frame is connected to the relative sliding member.

13. The anti-loose mechanism of the relative sliding rail as claimed in claim 10, wherein the main frame further comprises at least one hollow portion communicated to the accommodation portion, the pivotal seat comprises a rolling member corresponding to the hollow portion, and the rolling member of the pivotal seat is abutted against the sliding-guided portion of the sliding-guided member by passing through the hollow portion of the main frame.

14. The anti-loose mechanism of the relative sliding rail as claimed in claim 11, wherein the main frame further comprises at least one hollow portion communicated to the accommodation portion, the pivotal seat comprises a rolling member corresponding to the hollow portion, and the rolling member of the pivotal seat is abutted against the sliding-guided portion of the sliding-guided member by passing through the hollow portion of the main frame.

15. The anti-loose mechanism of the relative sliding rail as claimed in claim 12, wherein the main frame further comprises at least one hollow portion communicated to the accommodation portion, the pivotal seat comprises a rolling member corresponding to the hollow portion, and the rolling member of the pivotal seat is abutted against the sliding-guided portion of the sliding-guided member by passing through the hollow portion of the main frame.

16. The anti-loose mechanism of the relative sliding rail as claimed in claim 13, wherein the rolling member of the pivotal seat is pivotally disposed on an adjusting seat abutted against the pivotal seat via at least one elastic member.

17. The anti-loose mechanism of the relative sliding rail as claimed in claim 14, wherein the rolling member of the pivotal seat is pivotally disposed on an adjusting seat abutted against the pivotal seat via at least one elastic member.

18. The anti-loose mechanism of the relative sliding rail as claimed in claim 1, further comprising a pivotal seat pivotally disposed on the relative sliding member.

19. The anti-loose mechanism of the relative sliding rail as claimed in claim 2, further comprising a pivotal seat pivotally disposed on the relative sliding member.

20. The anti-loose mechanism of the relative sliding rail as claimed in claim 3, further comprising a pivotal seat pivotally disposed on the relative sliding member.

21. The anti-loose mechanism of the relative sliding rail as claimed in claim 18, wherein the protruded abutment is disposed on the pivotal seat.

22. The anti-loose mechanism of the relative sliding rail as claimed in claim 19, wherein the protruded abutment is disposed on the pivotal seat.

23. The anti-loose mechanism of the relative sliding rail as claimed in claim 20, wherein the protruded abutment is disposed on the pivotal seat.

24. The anti-loose mechanism of the relative sliding rail as claimed in claim 21, wherein the pivotal seat is connected to a pivotal frame via a pivot shaft, and the pivotal frame is connected to the relative sliding member.

25. The anti-loose mechanism of the relative sliding rail as claimed in claim 22, wherein the pivotal seat is connected to a pivotal frame via a pivot shaft, and the pivotal frame is connected to the relative sliding member.

26. The anti-loose mechanism of the relative sliding rail as claimed in claim 23, wherein the pivotal seat is connected to a pivotal frame via a pivot shaft, and the pivotal frame is connected to the relative sliding member.

27. The anti-loose mechanism of the relative sliding rail as claimed in claim 24, wherein the main frame further comprises at least one hollow portion communicated to the accommodation portion, the pivotal seat comprises a rolling member corresponding to the hollow portion, and the rolling member of the pivotal seat is abutted against the sliding-guided portion of the sliding-guided member by passing through the hollow portion of the main frame.

28. The anti-loose mechanism of the relative sliding rail as claimed in claim 25, wherein the main frame further comprises at least one hollow portion communicated to the accommodation portion, the pivotal seat comprises a rolling member corresponding to the hollow portion, and the rolling member of the pivotal seat is abutted against the sliding-guided portion of the sliding-guided member by passing through the hollow portion of the main frame.

29. The anti-loose mechanism of the relative sliding rail as claimed in claim 27, wherein the rolling member of the pivotal seat is pivotally disposed on an adjusting seat abutted against the pivotal seat via at least one elastic member.

30. The anti-loose mechanism of the relative sliding rail as claimed in claim 28, wherein the rolling member of the pivotal seat is pivotally disposed on an adjusting seat abutted against the pivotal seat via at least one elastic member.
